(19) United States
(12) Patent Application Publication
(10) Pub. No.: US 2014/0145682 A1
(43) Pub. Date: May 29, 2014

(54) BATTERY MANAGEMENT CIRCUIT AND BATTERY MANAGEMENT SYSTEM INCLUDING THE SAME

(71) Applicant: FAIRCHILD KOREA SEMICONDUCTOR LTD., Bucheon (KR)

(72) Inventors: Jintae KIM, Seoul (KR); Eun CHEON, Seoul (KR); Gwanbon KOO, Bucheon-si (KR)

(73) Assignee: FAIRCHILD KOREA SEMICONDUCTOR LTD., Bucheon (KR)

(21) Appl. No.: 14/091,682

(22) Filed: Nov. 27, 2013

(30) Foreign Application Priority Data
Nov. 27, 2012 (KR) 10-2012-0135570

(51) Int. Cl. H02J 7/00

(52) U.S. Cl. CPC H02J 7/007
USPC 320/135

(57) ABSTRACT

A battery management circuit and a battery management system including the same are provided. The battery management circuit is coupled to a plurality of battery cells, controls an input of a first pin to correspond to an input of a second pin, and determines a level of a receiving current based on a receiving signal that is input through the first pin. The battery management circuit includes a gate driving circuit including an on-transistor and an off-transistor in which a gate signal that is generated based on the receiving signal is input to a gate. A power supply voltage that is supplied from the plurality of battery cells is coupled to the second pin.

### CROSS-REFERENCE TO RELATED APPLICATION

This application claims priority to and the benefit of Korean Patent Application No. 10-2012-0135570 filed in the Korean Intellectual Property Office on Nov. 27, 2012, the entire contents of which are incorporated herein by reference.

### BACKGROUND

(a) Field

Embodiments relate to a circuit for managing a corresponding plurality of battery cells in a battery stack that is formed with a stacked plurality of battery cells and a battery management system including at least two battery management circuits.

(b) Description of the Related Art

By connecting in series a plurality of battery cells, a battery stack is formed, and power is supplied from the battery stack to a load. The number of a plurality of battery cells is determined according to a load. For example, as a capacity of a load increases, the number of a plurality of battery cells increases.

Because the number of battery cells in which a battery management circuit can control is limited, as the number of battery cells that are included in the battery stack increases, the number of battery management circuits increases. Each of a plurality of battery management circuits is connected to a corresponding plurality of battery cells in a battery stack to manage corresponding battery cells. In this case, a plurality of battery management circuits are connected to each other to form a stack structure.

A plurality of battery management circuits transmit and receive state information representing a state of battery cells. The battery management circuit includes a pin for transmitting and receiving state information.

For example, in a plurality of battery management circuits that are formed in a stack structure, a first pin for transferring state information in an upper direction and a second pin for transferring state information in a lower direction exist. In this case, the second pin may be a pin to be connected to a gate of a discharge switch of the battery management circuit.

That is, when the discharge switch is connected between a load and a negative electrode of a lowermost cell of a battery stack, a second pin of a lowermost battery management circuit of a plurality of battery management circuits is connected to a gate of the discharge switch. A gate signal that is transferred through the second pin controls a switching operation of the discharge switch.

The second pin of the battery management circuit is originally designed to be connected to a gate of the discharge switch, but in a plurality of battery management circuits that are connected in a stack structure, the second pin is used as a pin for outputting state information in a lower direction.

However, in a stack structure, the second pin of each battery management circuit and the ground of each battery management circuit are electrically connected, and a current path flowing to a next battery management circuit is formed. Therefore, an error occurs in transferring state information to a next battery management circuit.

The above information disclosed in this Background section is only for enhancement of understanding of the background of the invention and therefore it may contain information that does not form the prior art that is already known in this country to a person of ordinary skill in the art.

### SUMMARY

Embodiments provide a battery management circuit that manages corresponding battery cells of a plurality of battery cells constituting a battery stack and a battery management system including at least two battery management circuits.

An exemplary embodiment provides a battery management circuit that is connected to a plurality of battery cells. The battery management circuit includes: a receiver that controls an input of a first pin to correspond to an input of a second pin and that determines a level of a receiving current based on a receiving signal that is input through the first pin; and a gate driving circuit that includes an on-transistor and an off-transistor in which a gate signal that is generated based on the receiving signal is input to a gate. A power supply voltage that is supplied from the plurality of battery cells is coupled to the second pin.

The gate driving circuit may include a first current mirror circuit that is coupled to one end of the on-transistor, wherein the first current mirror circuit may include a first current source that supplies a driving current; a first transistor that has one end that is coupled to the first current source and the other end that is coupled to a first bias voltage and a control terminal that is coupled to the other end; and a second transistor that has one end that is coupled to one end of the on-transistor and a control terminal that is coupled to the control terminal of the first transistor and the other end that is coupled to the first bias voltage.

The off-transistor may have one end that is coupled to the ground and the other end that is coupled to the other end of the on-transistor.

The gate driving circuit may further include a first diode that is coupled to a third pin of the battery management circuit and that includes a cathode and an anode that is coupled to a first ground; and a second diode that includes an anode that is coupled to the third pin and a cathode that is coupled to the power supply voltage.

The other end of the on-transistor and the other end of the off-transistor may be coupled to a third pin, and the third pin may be coupled through a resistor to another battery management circuit adjacent to the battery management circuit or may be coupled to a discharge switch that controls discharge of the plurality of battery cells.

The receiver may include a linear regulator that includes a first input terminal and a second input terminal that are coupled to the first pin and the second pin, respectively, and that controls an input of the first input terminal to correspond to an input of the second input terminal; and a second current mirror circuit that generates a sensing voltage based on a comparison result of the receiving current that is transferred through the linear regulator and a predetermined reference current.

The linear regulator may include an error amplifier that includes the first input terminal and the second input terminal and that amplifies and outputs a difference between the input of the second input terminal and the input of the first input terminal; and a third transistor that has a control terminal to which an output of the error amplifier is coupled and one end that is coupled to the first pin and that is coupled to the second current mirror circuit. The receiving current may flow through the third transistor.

The second current mirror circuit may include a second current source that supplies the reference current using the second bias voltage; a fourth transistor that has one end that is coupled to the second current source and the other end that is coupled to the ground; and a fifth transistor that has one end to which the receiving current is supplied and a control terminal that is coupled to a control terminal of the fourth transistor and the other end that is coupled to the ground. The one end and the control terminal of the fifth transistor may be coupled.

The receiver may further include a comparator that generates the receiving signal based on a comparison result of a sensing voltage of one end of the fourth transistor and a predetermined reference voltage.

Another embodiment provides a battery management system including: a first battery management circuit that is coupled to a plurality of first battery cells; and a second battery management circuit that is coupled to a plurality of second battery cells adjacent to the plurality of first battery cells.

The first battery management circuit includes a linear regulator that controls an input of a first pin to correspond to an input of the second pin and in which a receiving current that is input through the first pin flows; and a first gate driving circuit that includes a first on-transistor and a first off-transistor in which a first gate signal is input to a gate, wherein the first battery management circuit determines the first gate signal based on the receiving current, and a first power supply voltage that is supplied from the plurality of first battery cells is coupled to the second pin.

The second battery management circuit may include a second gate driving circuit that includes a second on-transistor and a second off-transistor in which the second gate signal is input to a gate, wherein the second driving current may be supplied to the first battery management circuit, when the second on-transistor is turned on, and a second ground of the second battery management circuit may be coupled to the first battery management circuit, when the second off-transistor is turned on.

The second ground may be coupled to a contact point of the plurality of first battery cells and the plurality of second battery cells.

The second gate driving circuit may further include a third current mirror circuit that is coupled to one end of the second on-transistor, wherein the third current mirror circuit may include a third current source that supplies the second driving current; a sixth transistor that has one end that is coupled to the third current source and the other end that is coupled to the third bias voltage and a control terminal that is coupled to the other end; and a seventh transistor that has one end that is coupled to one end of the second on-transistor and a control terminal that is coupled to a control terminal of the sixth transistor and the other end that is coupled to the third bias voltage.

The second gate driving circuit may further include a fourth pin that is coupled to the first pin through a resistor; a third diode that includes a cathode that is coupled to the fourth pin and an anode that is coupled to a second ground; and a fourth diode that includes an anode that is coupled to the fourth pin and a cathode that is coupled to a second power supply voltage. The second power supply voltage may be supplied from the plurality of second battery cells.

The first gate driving circuit may include a first current mirror circuit that is coupled to one end of the first on-transistor, wherein the first current mirror circuit may include a first current source that supplies a first driving current; a first transistor that has one end that is coupled to the first current source and the other end that is coupled to a first bias voltage and a control terminal that is coupled to the other end; and a second transistor that has one end that is coupled to one end of the first on-transistor and a control terminal that is coupled to the control terminal of the first transistor and the other end that is coupled to the first bias voltage.

The first gate driving circuit may further include a first diode that is coupled to a third pin of the first battery management circuit and that includes a cathode and an anode that is coupled to a first ground; and a second diode that includes an anode that is coupled to the third pin and a cathode that is coupled to the first power supply voltage.

The other end of the first on-transistor and the other end of the first off-transistor may be coupled to the third pin, and the third pin may be coupled through a resistor to another battery management circuit that is in included in the battery management system or may be coupled to a discharge switch that controls discharge of a battery pack including the plurality of first and second battery cells.

The first battery management circuit may include a second current mirror circuit that generates a sensing voltage based on a comparison result of the receiving current that is transferred through the linear regulator and a predetermined reference current, and the receiving current may follow a second driving current that is supplied from the second battery management circuit.

The linear regulator may include an error amplifier that includes the first input terminal and the second input terminal and that amplifies and outputs a difference between the input of the second input terminal and the input of the first input terminal; and a third transistor that has a control terminal to which an output of the error amplifier is coupled and one end that is coupled to the first pin and that is coupled to the second current mirror circuit, wherein the receiving current may flow through the third transistor.

The second current mirror circuit may include a second current source that supplies the reference current using a second bias voltage; a fourth transistor that has one end that is coupled to the second current source and the other end that is coupled to a first ground; and a fifth transistor that has one end to which the receiving current is supplied and a control terminal that is coupled to a control terminal of the fourth transistor and the other end that is coupled to the first ground. The one end and the control terminal of the fifth transistor may be coupled.

According to embodiments, a battery management circuit that manages corresponding battery cells in a plurality of battery cells constituting a battery stack and a battery management system including at least two battery management circuits are provided.

According to embodiments, the number of pins of battery management circuits can be reduced because only one pin is used for driving of a gate and transfer of information. Stability of a system can be improved because a electrostatic discharge diode is provided in a gate driving pin (or information transfer pin).

### BRIEF DESCRIPTION OF THE DRAWINGS

FIG. 1 is a diagram illustrating a battery management system that is formed with a battery management circuit according to an exemplary embodiment.

FIG. 2 is a diagram illustrating a gate driving circuit and a receiver of two battery management circuits adjacent to a battery management circuit according to an exemplary embodiment.

FIG. 3 is a diagram illustrating a gate driving circuit and a receiver of a battery management circuit according to another exemplary embodiment.

### DETAILED DESCRIPTION OF THE EMBODIMENTS

In the following detailed description, only certain exemplary embodiments of the invention have been shown and described, simply by way of illustration. As those skilled in the art would realize, the described embodiments may be modified in various different ways, all without departing from the spirit or scope of the invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

Hereinafter, a battery management circuit and a battery management system including the same according to embodiments will be described with reference to the drawings.

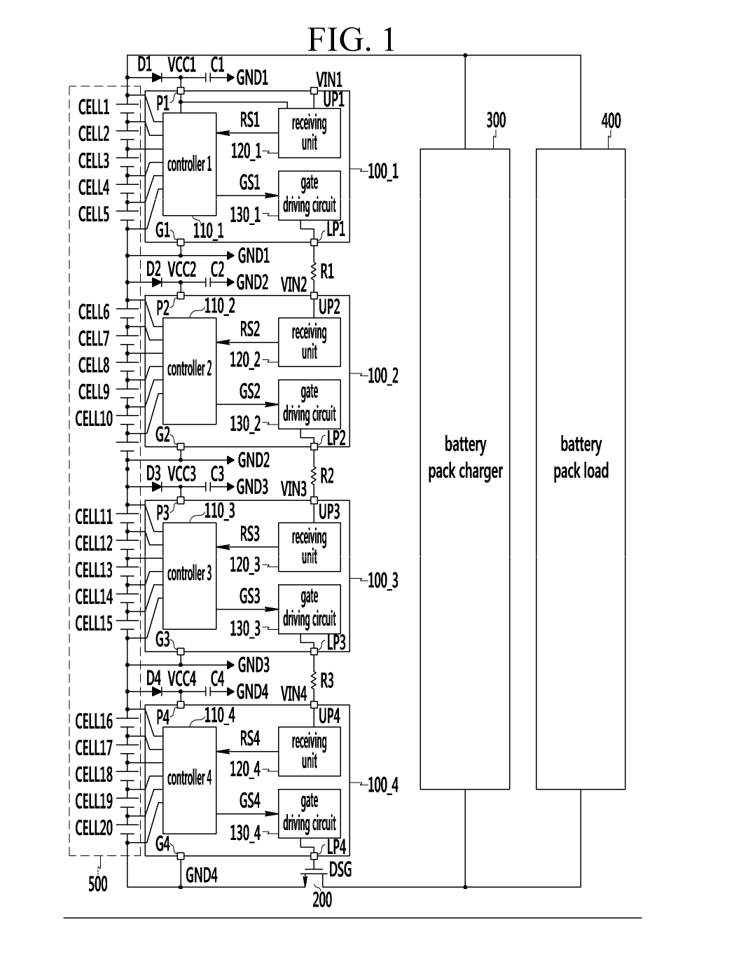

FIG. 1 is a diagram illustrating a battery management system that is formed with a battery management circuit according to an exemplary embodiment.

As shown in FIG. 1, a battery management circuit is formed in an integrated circuit, and a battery management circuit according to an exemplary embodiment is connected to a plurality of battery cells.

In FIG. 1, a battery pack 500 to which 20 battery cells are connected in series is managed by four battery management circuits 100_1-100_4. The number (e.g., 20) of a plurality of battery cells constituting the battery pack 500 and the number (e.g., 5) of a plurality of battery cells that are connected to one battery management circuit are an example. An exemplary embodiment of the invention is not limited thereto.

A battery pack charger 300 and a battery pack load 400 are connected to both ends of the battery pack 500. The battery pack charger 300 supplies a charge current for charging the battery pack 500. The battery pack load 400 operates by power that is supplied from the battery pack 500.

One end of the battery pack charger 300 and one end of the battery pack load 400 are connected to a positive electrode (+) of the battery pack 500. The other end of the battery pack charger 300 and the other end of the battery pack load 400 are connected to each other.

A discharge switch 200 is connected between a negative electrode (−) of the battery pack 500 and the other end of the battery pack charger 300. When the discharge switch 200 is turned on, a current that is supplied from the battery pack 500 flows to a battery load 400.

A gate of the discharge switch 200 is connected to a low-side pin LP4 of the battery management circuit 100_4, a discharge gate signal DSG that is transferred through the low-side pin LP4 is supplied, a source electrode of the discharge switch 200 is connected to a negative electrode (−) of the battery pack 500, and a drain electrode of the discharge switch 200 is connected to the other end of the battery pack load 400.

In FIG. 1, each of the battery management circuits 100_1-100_4 transmits and receives state information to and from adjacent battery management circuits. State information is information representing a normal state or an abnormal state. Receivers 120_1-120_4 of FIG. 1 are a means that receives state information that is transferred from adjacent upper battery management circuits, and gate driving circuits 130_1-130_4 are a means that sends state information to adjacent lower battery management circuits.

However, an exemplary embodiment of the invention is not limited to a description that is described with reference to FIG. 1 and may further include a means that sends state information to adjacent upper battery management circuits and a means that receives state information that is transferred from adjacent lower battery management circuits. However, for a description of a linear regulator according to an exemplary embodiment, only receivers 120_1-120_4 and gate driving circuits 130_1-130_4 are illustrated in FIG. 1. Further, a upper and a lower are divided in consideration of only a position that is shown in FIG. 1.

The battery management circuit 100_1 measures a voltage of each of a plurality of battery cells CELL1-CELL5, and when measured voltages of the plurality of battery cells CELL1-CELL5 are in a predetermined range, it is determined as a normal state.

The battery management circuit 100_2 measures a voltage of each of a plurality of battery cells CELL6-CELL10, and when measured voltages of the plurality of battery cells CELL6-CELL10 are in a predetermined range, it is determined as a normal state.

The battery management circuit 100_3 measures a voltage of each of a plurality of battery cells CELL11-CELL15, and when measured voltages of the plurality of battery cells CELL11-CELL15 are in a predetermined range, it is determined as a normal state.

The battery management circuit 100_4 measures a voltage of each of a plurality of battery cells CELL16-CELL20, and when measured voltages of the plurality of battery cells CELL16-CELL20 are in a predetermined range, it is determined as a normal state.

The battery management circuit 100_1 transmits state information to the adjacent battery management circuit 100_2. Because the battery management circuit 100_1 is positioned at an uppermost position, state information that is received from an adjacent upper battery management circuit to the battery management circuit 100_1 does not exist. The battery management circuit 100_4 receives state information from the adjacent battery management circuit 100_3. Because the battery management circuit 100_4 is positioned at the lowest end, state information to transmit from the battery management circuit 100_4 to a lower battery management circuit does not exist. However, as described above, the battery management circuit 100_4 outputs a discharge gate signal that controls a switching operation of the discharge switch 200.

The battery management circuit 100_2 transmits state information to the adjacent battery management circuit 100_3. The battery management circuit 100_3 transmits state information to the adjacent battery management circuit 100_4.

The battery management circuits 100_1-100_4 each include a power supply pin, a ground pin, an up-side pin, and a low-side pin. In order to distinguish the same function pins of each of the battery management circuits 100_1-100_4, references numeral and numerals representing a pin are together described.

Power supply voltages VCC1-VCC4 necessary for operation of the battery management circuits 100_1-100_4 are supplied to power supply pins P1-P4. For example, a capacitor C1 is connected to a positive electrode of the battery cell CELL1 through a diode D1, and a capacitor C1 is charged by a voltage that is supplied from a battery cell and thus a power supply voltage VCC1 is generated. Similarly, a power supply voltage VCC2, a power supply voltage VCC3, and a power supply voltage VCC3 are charged to a capacitor C2, a capacitor C3, and a capacitor C4, respectively.

The power supply pins P1-P4 are connected to a capacitor (one of C1-C4) corresponding to a positive electrode of a battery cell of a highest potential in a plurality of battery cells that are connected to each of the battery management circuits 100_1-100_4. Power supply pins of each of the battery management circuits 100_1-100_4 are represented with P1, P2, P3, and P4.

A reference voltage is supplied to the battery management circuits 100_1-100_4 through ground pins G1-G4. Ground pins of each of the battery management circuits 100_1-100_4 are represented with G1, G2, G3, and G4. For example, the ground pins G1-G4 are connected to a negative electrode of a battery cell of a lowest potential in a plurality of battery cells that are connected to each of the battery management circuits 100_1-100_4. The ground pin G1 is connected to a negative electrode of the battery cell CELL5, and a voltage of a negative electrode of the battery cell CELL5 becomes a voltage of the ground GND1 of the battery management circuit 100_1.

Similarly, the ground pin G2 is connected to a negative electrode of the battery cell CELL10, the ground pin G3 is connected to a negative electrode of the battery cell CELL15, and the ground pin G4 is connected to a negative electrode of the battery cell CELL20. A voltage of the grounds GND2, GND3, and GND4 of each of the battery management circuits 100_2-100_4 is a negative electrode voltage of the battery cells CELL10, CELL15, and CELL15.

The battery management circuits 100_1-100_3 transmit state information of a corresponding battery management circuit to up-side pins UP2-UP4 of the adjacent battery management circuits 100_2-100_4 in a lower direction through low-side pins LP1-LP3.

Because an adjacent battery management circuit does not exist in an upper direction of the battery management circuit 100_1, an up-side pin UP1 of the battery management circuit 100_1 is in a floating state. An adjacent battery management circuit does not exist in a lower direction of the battery management circuit 100_4, but the low-side pin LP4 of the battery management circuit 100_4 is connected to a gate electrode of the discharge switch 200. The discharge gate signal DSG is supplied to a gate electrode of the discharge switch 200 through the low-side pin LP4.

A resistor exists between an up-side pin and a low-side pin of each of two adjacent battery management circuits. For example, a resistor R1 exists between the low-side pin LP1 of the battery management circuit 100_1 and the up-side pin UP2 of the battery management circuit 100_2, a resistor R2 exists between the low-side pin LP2 of the battery management circuit 100_2 and the up-side pin UP3 of the battery management circuit 100_3, and a resistor R3 exists between the low-side pin LP3 of the battery management circuit 100_3 and the up-side pin UP4 of the battery management circuit 100_4.

The battery management circuits 100_1-100_4 each include a controller, a receiver, and a gate driving circuit.

The controllers 110_1-110_4 determine a state according to a measured result of a voltage of corresponding battery cells. That is, state information of the corresponding battery management circuits 100_1-100_4 is determined by the controllers 110_1-110_4.

The controllers 110_1-110_4 generate a gate signal according to state information of an adjacent battery management circuit that receives through receivers 120_1-120_4 and state information of a corresponding battery management circuit. Each of the receivers 120_1-120_4 generate receiving signals RS1-RS4 corresponding to state information according to input voltages VIN1-VIN4 that are input from corresponding up-side pins UP1-UP4.

Each of the controllers 110_1-110_4 determines state information of a corresponding battery management circuit according to a measured result of a voltage of corresponding battery cells and a corresponding receiving signal and generates a gate signal according to the state information.

In order to distinguish the same function configurations of each of the battery management circuits 100_1-100_4, reference numerals and numerals representing a corresponding configuration are together described.

That is, the battery management circuit 100_1 includes a controller 110_1, a receiver 120_1, and a gate driving circuit 130_1. An adjacent battery management circuit does not exist in an upper direction of the battery management circuit 100_1, but the battery management circuit 100_1 may include a receiver 120_1. However, an exemplary embodiment of the invention is not limited thereto and may not include the receiver 120_1.

The battery management circuit 100_2 includes a controller 110_2, a receiver 120_2, and a gate driving circuit 130_2. The battery management circuit 100_3 includes a controller 110_3, a receiver 120_3, and a gate driving circuit 130_3.

The battery management circuit 100_4 includes a controller 110_4, a receiver 120_4, and a gate driving circuit 130_4. An adjacent battery management circuit does not exist in a lower direction of the battery management circuit 100_4, but the battery management circuit 100_4 may include the gate driving circuit 130_4. An output of the gate driving circuit 130_4 performs a function of the discharge gate signal DSG.

In the battery management circuit 100_1, the controller 110_1 receives an input of a receiving signal RS1 from the receiver 120_1 and supplies a gate signal GS1 to the gate driving circuit 130_1. Because an adjacent battery management circuit does not exist in an upper direction of the battery management circuit 100_1, the receiving signal RS1 may be a signal representing always a normal state. For example, a signal representing a normal state may be in a high level.

In the battery management circuit 100_2, the controller 110_2 receives an input of a receiving signal RS2 from the receiver 120_2 and supplies a gate signal GS2 to the gate driving circuit 130_2. In the battery management circuit 100_3, the controller 110_3 receives an input of a receiving signal RS3 from the receiver 120_3 and supplies a gate signal GS3 to the gate driving circuit 130_3.

In the battery management circuit 100_4, the controller 110_4 receives an input of the receiving signal RS4 from the receiver 120_4 and supplies a gate signal GS4 to the gate driving circuit 130_4. The gate driving circuit 130_4 generates a discharge gate signal DSG according to the gate signal GS4.

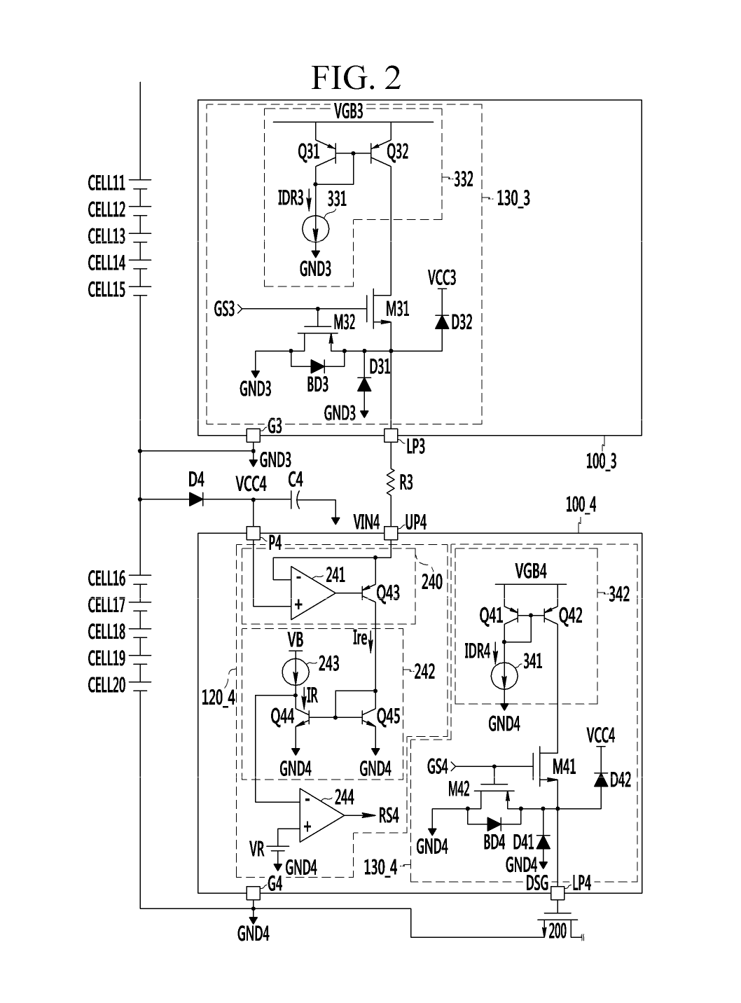

Hereinafter, a gate driving circuit and a receiver according to an exemplary embodiment will be described with reference to FIG. 2.

FIG. 2 is a diagram illustrating a gate driving circuit and a receiver of two battery management circuits adjacent to a battery management circuit according to an exemplary embodiment.

FIG. 2 illustrates a gate driving circuit 130_3 of the battery management circuit 100_3, and a receiver 120_4 and a gate driving circuit 130_4 of the battery management circuit 100_4. Receivers 120_1, 120_2, and 120_3 of the respective battery management circuits 100_1, 100_2, and 100_3 may be formed in the same structure as that of the receiver 1204 that is shown in FIG. 2, and gate driving circuits 130_1 and 130_2 may be also formed in the same structure as that of gate driving circuits 130_3 and 130_4 that are shown in FIG. 2.

The gate driving circuit 130_3 includes a current mirror circuit 332, an on-transistor M31, an off-transistor M32, and two diodes D31 and D32.

The current mirror circuit 332 includes a BJT Q31, a BJT Q32, and a current source 331. A collector of the BJT Q31 is connected to a bias voltage VGB3, and a base and an emitter of the BJT Q31 are connected to each other. The current source 331 is connected between a ground GND3 of the battery management circuit 100_3 and an emitter of the BJT Q31. A collector of the BJT Q32 is connected to the bias voltage VGB3, a base of the BJT Q32 is connected to a base of the BJT Q31, and an emitter of the BJT Q32 is connected to a drain of the on-transistor M31.

A gate of the on-transistor M31 is connected to the gate signal GS3, and a source of the on-transistor M31 is connected to the low-side pin LP3. A gate of the off-transistor M32 is connected to the gate signal GS3, a source of the off-transistor M32 is connected to the low-side pin LP3, and a drain of the off-transistor M32 is connected to the ground GND3. A body diode BD3 that is formed between the drain-source of the off-transistor M32 is connected between the ground GND3 and the low-side pin LP3.

The on-transistor M31 is an N-channel transistor, and the off-transistor M32 is a P-channel transistor. When the gate signal GS3 is in a high level, the on-transistor M31 is turned on, and the off-transistor M32 is turned off. When the gate signal GS3 is in a low level, the on-transistor M31 is turned off, and the off-transistor M32 is turned on.

A cathode of the diode D31 is connected to the low-side pin LP3, and an anode of the diode D31 is connected to the ground GND3. A cathode of the diode D32 is connected to a power supply voltage VCC3 of the battery management circuit 100_3, and an anode of the diode D32 is connected to the low-side pin LP3. The diode D31 and the diode D32 are electrostatic discharge diodes of the battery management circuit 100_3. For example, a surge current generated by electrostatic discharge at the low-side pin LP3 is discharged through the diode D31 or the diode D32.

When the on-transistor M31 is turned on (when the off-transistor M32 is turned off), the current mirror circuit 332 outputs a current that copies a driving current IDR3 and enables the current to flow to the battery management circuit 100_4 through the low-side pin LP3. Therefore, a voltage drop occurs in the resistor R3 between the up-side pin UP4 and the low-side pin LP3. A voltage drop occurs by a voltage that multiplies the driving current IDR3 and the resistor R3.

When the off-transistor M32 is turned on (when the on-transistor M31 is turned off), the current mirror circuit 332 does not operate. The low-side pin LP3 is connected to the ground GND3 through the off-transistor M32.

The receiver 120_4 controls an input voltage VIN4 that is input through the up-side pin UP4 to correspond to a power supply voltage VCC4 and determines a level of the receiving signal RS4 according to a receiving current Ire that is input through the up-side pin UP4. The receiver 120_4 includes a linear regulator 240, a current mirror circuit 242, and a comparator 244.

The linear regulator 240 is connected to an up-side pin UP4 and a power supply pin P4 and controls the input voltage VIN4 that is input through the up-side pin UP4 of the battery management circuit 100_4 to the power supply voltage VCC4. Because the power supply voltage VCC4 is the same as the ground GND3 voltage, when the low-side pin UP3 is connected to the ground GND3, both end voltages of the resistor R3 are the same and thus a current does not flow.

The linear regulator 240 includes an error amplifier 241 and a BJT Q43. The error amplifier 241 generates an output according to a difference between an input of an inversion terminal (−) and an input of a non-inversion terminal (+), and an output of the error amplifier 241 is connected to a base of the BJT Q43. Therefore, the input of the inversion terminal (−) and the input of the non-inversion terminal (+) are equally controlled.

For example, when the input of the inversion terminal (−) increases, compared with the input of the non-inversion terminal (+), an output of the error amplifier 241 decreases, and because the BJT Q43 is a pnp type, resistance of the BJT Q43 decreases. Therefore, a collector current of the BJT Q43 increases and a voltage of the inversion terminal (−) decreases to be controlled to correspond to a voltage of the non-inversion terminal (+).

In contrast, when the input of the inversion terminal (−) decreases, compared with the input of the non-inversion terminal (+), an output of the error amplifier 241 increases and resistance of the BJT Q43 increases. Therefore, a collector current of the BJT Q43 decreases, and a voltage of the inversion terminal (−) increases to correspond to a voltage of the non-inversion terminal (+).

In such a method, the input of the inversion terminal (−) is controlled to correspond to the input of the non-inversion terminal (+).

A collector of the BJT Q43 is connected to the up-side pin UP4 and the inversion terminal (−) of the error amplifier 241, and an emitter of the BJT Q43 is connected to the current mirror circuit 242. A current flowing to the BJT Q43 is transferred to the current mirror circuit 242.

The current mirror circuit 242 compares a receiving current Ire that is transferred through the linear regulator 240 and a reference current IR and senses state information that is received from an upper end portion. The current mirror circuit 242 includes a current source 243, a BJT Q44, and a BJT Q45.

A collector of the BJT Q45 is connected to an emitter of the BJT Q43, an emitter of the BJT Q45 is connected to a ground GND4 of the battery management circuit 100_4, and a base of the BJT Q45 is connected to a collector. A base of the BJT Q44 is connected to a base of the BJT Q45, a collector of the BJT Q45 is connected to the current source 243, and an emitter of the BJT Q45 is connected to the ground GND4.

The current source 243 generates a reference current IR through a bias voltage VB. A collector in which the BJT Q44 and the current source 243 are connected is connected to an inversion terminal (−) of the comparator 244, and a non-inversion terminal (+) of the comparator 244 is connected to a reference voltage VR. When an input of the non-inversion terminal (+) is equal to or lager than an input of the inversion terminal (−), the comparator 244 generates a receiving signal RS4 of a high level. When an input of the non-inversion terminal (+) is smaller than that of the inversion terminal (−), the comparator 244 generates a receiving signal RS4 of a low level.

As a transistor M31 of the gate driving circuit 130_3 is turned on, when the driving current IDR3 flows, a receiving current Ire is a driving current IDR3. Because the driving current IDR3 is a current very higher than the reference current IR, a collector voltage of the BJT Q44 becomes a voltage of the ground GND4.

Because the voltage of the ground GND4 is smaller than the reference voltage VR, when the transistor M31 is turned on (i.e., when the gate signal GS3 is in a high level according to a normal state), the receiving signal RS4 becomes a high level.

As a transistor M32 of the gate driving circuit 130_3 is turned on, when the driving current IDR3 does not flow, a receiving current Ire does not occur. Therefore, a collector voltage of the BJT Q44 becomes the bias voltage VB of the current source 243.

Because the bias voltage VB is larger than the reference voltage VR, when the transistor M32 is turned on(i.e., when the gate signal GS3 is in a low level according to an abnormal state), the receiving signal RS4 becomes a low level.

A collector voltage of the BJT Q44 is a sensing voltage representing state information that receives from an upper end portion. The current mirror circuit 242 generates a sensing voltage according to a comparison result of the receiving current Ire and the reference current Ire, and the sensing voltage follows state information that receives from an upper end portion.

The controller 110_4 generates a gate signal GS4 of a high level according to the receiving signal RS4 of a high level, transfers the gate signal GS4 to the gate driving circuit 130_4, generates a gate signal SG4 of a low level according to the receiving signal RS4 of a low level, and transfers the gate signal SG4 to the gate driving circuit 130_4.

The gate driving circuit 130_4 includes a current mirror circuit 342, an on-transistor M41, an off-transistor M42, and two diodes D41 and D42.

The current mirror circuit 342 includes a BJT Q41, a BJT Q42, and a current source 341. A collector of the BJT Q41 is connected to a bias voltage VGB4, and a base and an emitter of the BJT Q41 are connected to each other. The current source 341 is connected between the ground GND4 of the battery management circuit 100_4 and an emitter of the BJT Q41. A collector of the BJT Q42 is connected to the bias voltage VGB4, a base of the BJT Q42 is connected to a base of the BJT Q41, and an emitter of the BJT Q42 is connected to a drain of the on-transistor M41.

A gate of the on-transistor M41 is connected to the gate signal GS4, and a source of the on-transistor M41 is connected to the low-side pin LP4. A gate of the off-transistor M42 is connected to the gate signal GS4, a source of the off-transistor M42 is connected to the low-side pin LP4, and a drain of the off-transistor M42 is connected to the ground GND4. A body diode BD4 that is formed between the drain-source of the off-transistor M42 is connected between the ground GND4 and the low-side pin LP4.

The on-transistor M41 is an N-channel transistor, and the off-transistor M42 is a P-channel transistor. When the gate signal GS4 is in a high level, the on-transistor M41 is turned on, and the off-transistor M42 is turned off. When the gate signal GS4 is in a low level, the on-transistor M41 is turned off, and the off-transistor M42 is turned on.

A cathode of a diode D41 is connected to the low-side pin LP4, and an anode of the diode D41 is connected to the ground GND4. A cathode of a diode D42 is connected to the power supply voltage VCC4 of the battery management circuit 100_4, and an anode of the diode D32 is connected to the low-side pin LP3. The diode D41 and the diode D42 are electrostatic discharge diodes of the battery management circuit 100_4. For example, a surge current generated by electrostatic discharge at the low-side pin LP4 is discharged through the diode D41 or the diode D42.

When the on-transistor M41 is turned on(when the off-transistor M42 is turned off), the current mirror circuit 342 outputs a current that copies the driving current IDR3 and enables the current to flow to a gate of the discharge switch 200 through the low-side pin LP4. Therefore, a gate voltage of the discharge switch 200 increases to be turned on.

When the off-transistor M42 is turned on(when the on-transistor M31 is turned off), the current mirror circuit 342 does not operate. The low-side pin LP4 is connected to the ground GND4 through the off-transistor M42. Therefore, a gate voltage of the discharge switch 200 becomes a voltage of the ground GND4 to be turned off.

An exemplary embodiment controls an input voltage that is input through an up-side pin and a linear regulator to a power supply voltage. Therefore, in an abnormal state, a discharge switch may be turned off without delay.

Conventionally, when a battery management circuit that does not include a linear regulator is formed in a stack structure, in a condition in which an abnormal state occurs, there is a problem that grounds between two adjacent battery management circuits are connected to form a current path. For example, in FIG. 2, a current path including the ground GND3, the

off-transistor M32 in turned on, the resistor R3, the BJT Q4, and the ground GND4 may be formed. Therefore, because a voltage of the non-inversion terminal (−) of the comparator 244 is lower than the reference voltage VR, the receiving signal RS4 may be in a high level. That is, a serious erroneous operation in which state information representing an abnormal state may be not transferred and in which the receiving signal RS4 maintains in a high level may occur.

However, in an exemplary embodiment, as a linear regulator 120_4 is formed between the resistor R3 and the BJT Q4, both end voltages of the resistor R3 are the same, and thus when an abnormal state occurs, a current does not flow to the resistor R3 and thus a current that flows the linear regulator 120_4 does not occur.

Therefore, a receiving current Ire does not occur and thus a collector of the BJT Q44 becomes the bias voltage VB, and a voltage of the non-inversion terminal (−) of the comparator 244 becomes a voltage higher than the reference voltage VR. Therefore, as the receiving signal RS4 becomes a low level and the gate signal GS4 becomes a low level, the discharge gate signal DSG becomes also a low level (the ground GND4).

In this way, state information according to an abnormal state is accurately transferred to a lowermost battery management circuit and thus the discharge switch 200 is turned off.

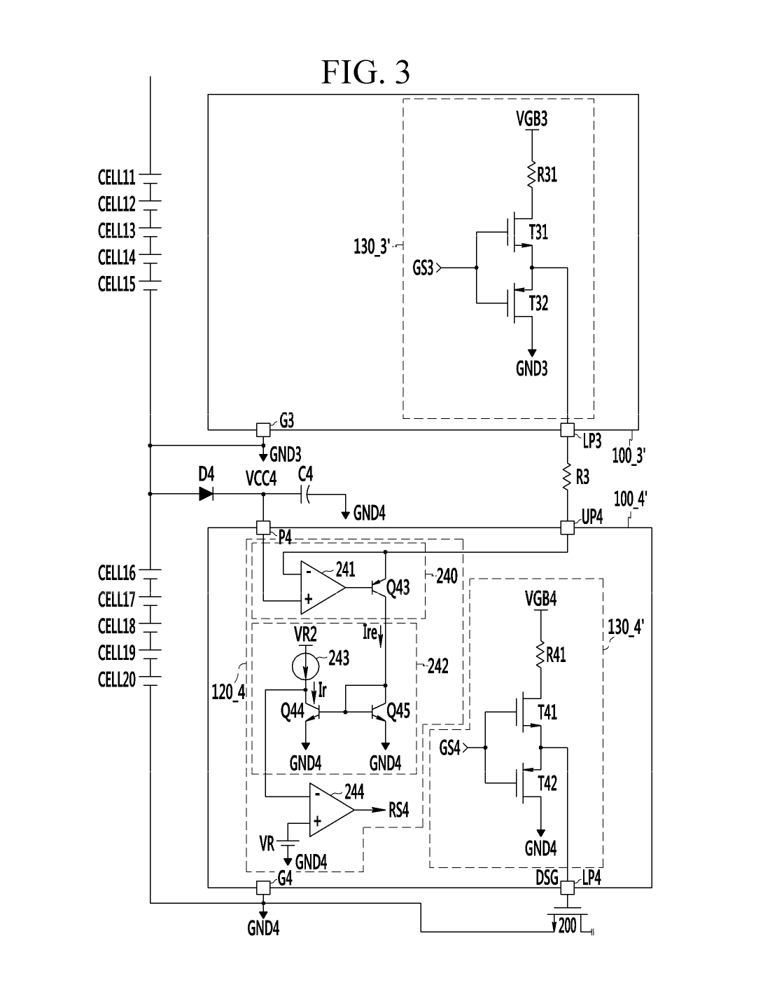

Hereinafter, a battery management circuit according to another exemplary embodiment of the invention will be described with reference to FIG. 3.

FIG. 3 is a diagram illustrating a receiver and a gate driving circuit of a battery management circuit according to another exemplary embodiment.

The battery management circuit that is shown in FIG. 3 is different from the battery management circuit that is shown in FIG. 2 in a configuration and a connecting relationship of a gate driving circuit. Further, in FIG. 3, for a description of a changed gate driving circuit, only a battery management circuit 100_3′ and a battery management circuit 100_4′ are illustrated. Because a configuration of a receiver of another exemplary embodiment is the same as that of the foregoing exemplary embodiment, a description of the same elements as those of the foregoing exemplary embodiment will be omitted.

The gate driving circuit 130_3′ supplies a driving current to the low-side pin LP3 according to the gate signal GS3, or connects the ground GND3 to the low-side pin LP3. The gate driving circuit 130_3′ includes a resistor R31, an on-transistor T31, and an off-transistor T32.

The resistor R31 is connected between the bias voltage VGB3 and the on-transistor T31. A drain of the on-transistor T31 is connected to the resistor R31, and a gate of the on-transistor T31 is connected to the gate signal GS3. A drain of the off-transistor T32 is connected to the ground GND3, and a gate of the off-transistor T32 is connected to the gate signal GS3. A source of the on-transistor T31 and a source of the off-transistor T32 are connected to each other, and a contact point thereof is connected to the low-side pin LP3.

A gate driving circuit 130_4′ supplies a driving current to the low-side pin LP4 according to the gate signal GS4, or connects the ground GND3 to the low-side pin LP4. The gate driving circuit 130_4′ includes a resistor R41, an on-transistor T41, and an off-transistor T42.

The resistor R41 is connected between the bias voltage VGB4 and the on-transistor T41. A drain of an on-transistor T41 is connected to the resistor R41, and a gate of the on-transistor T41 is connected to the gate signal GS4. A drain of the off-transistor T42 is connected to the ground GND4, and a gate of the off-transistor T42 is connected to the gate signal GS4. A source of the on-transistor T41 and a source of the off-transistor T42 are connected to each other, and a contact point thereof is connected to the low-side pin LP4.

The low-side pin LP4 is connected to a gate of the discharge switch 200, and the discharge gate signal DSG that controls a switching operation of the discharge switch 200 is output through the low-side pin LP4.

When the on-transistor T31 is turned on (when the off-transistor T32 is turned off), a driving current flowing to the on-transistor T31 by the bias voltage VGB3 is supplied to the battery management circuit 100_4 through the resistor R3.

A driving current flows through the BJT Q43 and the BJT Q45, and because a driving current is larger than the reference current IR, a collector voltage of the BJT Q44 becomes a voltage of the ground GND4. Therefore, the comparator 244 generates a receiving signal RS4 of a high level. By the receiving signal RS4 of a high level, the gate signal GS4 becomes a high level and the on-transistor T41 is turned on.

When the on-transistor T41 is turned on (when the off-transistor T42 is turned off), a driving current flowing to the on-transistor T41 is supplied to a gate of the discharge switch 200 through the low-side pin LP4 by the bias voltage VGB4 and thus a gate voltage increases, and the discharge switch 200 is turned on.

When the off-transistor T32 is turned on (when the on-transistor T31 is turned off), the low-side pin LP3 is connected to the ground GND3 through the off-transistor M32.

A voltage of the up-side pin UP4 is controlled to the power supply voltage VCC4 by the linear regulator 120_4, and a voltage of the ground GND3 and a voltage of the power supply voltage VCC4 are the same, and both end voltages of the resistor R3 are thus the same and thus a current does not flow to the resistor R3.

Because a current does not flow to the linear regulator 120_4, a receiving current Ire does not flow. That is, because the receiving current Ire is smaller than the reference current IR, a collector voltage of the BJT Q44 becomes the bias voltage VB. Thereafter, the comparator 244 generates a receiving signal RS4 of a low level.

By the receiving signal RS4 of a low level, the gate signal GS4 becomes a low level, and the off-transistor M42 is turned on.

When the off-transistor M42 is turned on (when the on-transistor M31 is turned off), the low-side pin LP4 is connected to the ground GND4 through the off-transistor M42. Therefore, a gate voltage of the discharge switch 200 becomes a voltage of the ground GND4 to be turned off.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

battery management circuits 100_1-100_4, battery pack 500

resistors R31-R41, controllers 110_1-110_4

receivers 120_1-120_4, gate driving circuits 130_1-130_4

battery cells CELL1-CELL20, discharge control switch 200

battery pack charger 300, battery pack load 400

current mirror circuits 332 and 242, on-transistors M31 and T31

off-transistors M32 and T32, diodes D31 and D32

BJTs Q31, Q32, and Q41-Q45, current sources 331, 243, and 341

linear regulator 240, comparator 244, error amplifier 241

battery management circuits 100_3′ and 100_4′

gate driving circuits 130_3′ and 130_4′

What is claimed is:

1. A battery management circuit that is connected to a plurality of battery cells, the battery management circuit comprising:
a receiver configured to control an input of a first pin to correspond to an input of a second pin and to determine a level of a receiving current based on a receiving signal that is input to the first pin; and
a gate driving circuit including an on-transistor and an off-transistor, a gate of the on-transistor and a gate of the off-transistor coupled to a gate signal generated based on the receiving signal,
wherein a power supply voltage from the plurality of battery cells is supplied to the second pin.

2. The battery management circuit of claim 1, wherein the gate driving circuit includes a first current mirror circuit coupled to a first terminal of the on-transistor,
the first current mirror circuit including,
a current source configured to supply a driving current;
a first transistor having a first terminal coupled to the current source, a second terminal coupled to a bias voltage and a control terminal coupled to the first terminal; and
a second transistor having a first terminal coupled to the first terminal of the on-transistor, a control terminal coupled to the control terminal of the first transistor and a second terminal coupled to the bias voltage.

3. The battery management circuit of claim 2, wherein the off-transistor has a first terminal coupled to a first reference potential and a second terminal coupled to a second terminal of the on-transistor.

4. The battery management circuit of claim 1, wherein the gate driving circuit further comprises:
a first diode having a cathode coupled to a third pin of the battery management circuit and an anode coupled to a reference potential; and
a second diode having an anode coupled to the third pin and a cathode coupled to the power supply voltage.

5. The battery management circuit of claim 1, wherein the on-transistor and the off-transistor are coupled to a third pin, and the third pin is coupled through a resistor to another battery management circuit adjacent to the battery management circuit or is coupled to a discharge switch configured to control discharge of the plurality of battery cells.

6. The battery management circuit of claim 1, wherein the receiver comprises:
a linear regulator including a first input terminal and a second input terminal coupled to the first pin and the second pin, respectively, the linear regulator configured to control an input of the first input terminal to correspond to an input of the second input terminal; and
a second current mirror circuit configured to generate a sensing voltage based on a comparison result of the receiving current and a predetermined reference current.

7. The battery management circuit of claim 6, wherein the linear regulator comprises:
an error amplifier including the first input terminal and the second input terminal and configured to amplify and output a difference between the second input terminal and the first input terminal; and
a third transistor having a control terminal coupled to an output of the error amplifier, a first terminal coupled to the first pin and a second terminal coupled to the second current mirror circuit,
wherein the receiving current flows through the third transistor.

8. The battery management circuit of claim 6, wherein the second current mirror circuit comprises:
a current source configured to supply the reference current using a bias voltage;
a fourth transistor having a first terminal coupled to the current source and a second terminal coupled to a first reference potential; and
a fifth transistor having a first terminal to which the receiving current is supplied, a control terminal coupled to the first terminal and a control terminal of the fourth transistor, and a second terminal coupled to the first reference potential.

9. The battery management circuit of claim 8, wherein the receiver further comprises:
a comparator configured to generate the receiving signal based on a comparison result of a sensing voltage of the first terminal of the fourth transistor and a predetermined reference voltage.

10. A battery management system, comprising:
a first battery management circuit coupled to a plurality of first battery cells; and
a second battery management circuit coupled to a plurality of second battery cells adjacent to the plurality of first battery cells,
wherein the first battery management circuit includes,
a linear regulator configured to control an input of a first pin to correspond to an input of a second pin and in which a receiving current input to the first pin flows; and
a first gate driving circuit including a first on-transistor and a first off-transistor, a gate of the first on-transistor and a gate of the first off-transistor coupled to a first gate signal,
wherein the first battery management circuit determines the first gate signal based on the receiving current, and a first power supply voltage supplied from the plurality of first battery cells is coupled to the second pin.

11. The battery management system of claim 10, wherein the second battery management circuit further comprises:
a second gate driving circuit having a second on-transistor and a second off-transistor, a gate of the second on-transistor and a gate of the second off-transistor coupled to a second gate signal,
wherein a second driving current is supplied to the first battery management circuit if the second on-transistor is turned on, and a reference potential of the second battery management circuit is coupled to the first battery management circuit if the second off-transistor is turned on.

12. The battery management system of claim 11, wherein the reference potential is coupled to a contact point of the plurality of first battery cells and the plurality of second battery cells.

13. The battery management system of claim 10, wherein the second gate driving circuit further comprises:
a third current mirror circuit coupled to a first terminal of the second on-transistor,
wherein the third current mirror circuit includes,
a current source configured to supply the second driving current;
a sixth transistor having a first terminal coupled to the current source, a second terminal coupled to a bias voltage and a control terminal coupled to the first terminal; and
a seventh transistor having a first terminal coupled to the second on-transistor, a control terminal coupled to the control terminal of the sixth transistor and a second terminal coupled to the bias voltage.

14. The battery management system of claim 13, wherein the second gate driving circuit further comprises:
a third pin coupled to the first pin through a resistor;
a third diode having a cathode coupled to the third pin and an anode coupled to a reference potential; and
a fourth diode having an anode coupled to the third pin and a cathode coupled to a second power supply voltage, the second power supply voltage supplied from the plurality of second battery cells.

15. The battery management system of claim 10, wherein the first gate driving circuit comprises:
a first current mirror circuit coupled to the first on-transistor, the first current mirror circuit including,
a current source configured to supply a first driving current;
a first transistor having a first terminal coupled to the current source, a second terminal coupled to a bias voltage, and a control terminal coupled to the first terminal; and
a second transistor having a first terminal coupled to the first on-transistor, a control terminal coupled to the control terminal of the first transistor and a second terminal coupled to the bias voltage.

16. The battery management system of claim 10, wherein the first gate driving circuit further comprises:
a first diode having a cathode coupled to a third pin of the first battery management circuit and an anode coupled to a reference potential; and
a second diode having an anode coupled to the third pin and a cathode coupled to the first power supply voltage.

17. The battery management system of claim 10, wherein the first on-transistor and the first off-transistor are coupled to the third pin, and
the third pin is coupled through a resistor to another battery management circuit that is in included in the battery management system or is coupled to a discharge switch configured to control discharge of a battery pack including the plurality of first and second battery cells.

18. The battery management system of claim 10, wherein the first battery management circuit comprises:
a second current mirror circuit configured to generate a sensing voltage based on a comparison result of the receiving current and a predetermined reference current, and
the receiving current follows a second driving current supplied from the second battery management circuit.

19. The battery management system of claim 18, wherein the linear regulator comprises:
an error amplifier including a first input terminal coupled to the first pin and a second input terminal coupled to the second pin, the error amplifier configured to amplify and output a difference between the second input terminal and the first input terminal; and
a third transistor having a control terminal coupled to an output of the error amplifier, a first terminal coupled to the first pin and a second terminal coupled to the second current mirror circuit,
wherein the receiving current flows through the third transistor.

20. The battery management system of claim 18, wherein the second current mirror circuit comprises:
a current source configured to supply the reference current using a bias voltage;
a fourth transistor having a first terminal coupled to the current source and a second terminal coupled to a reference potential; and
a fifth transistor having a first terminal to which the receiving current is supplied, a control terminal coupled to the first terminal and a control terminal of the fourth transistor, and a second terminal coupled to the reference potential.
